(19) United States
(12) Patent Application Publication
(10) Pub. No.: US 2026/0054956 A1
(43) Pub. Date: Feb. 26, 2026

(54) CABLE ABNORMALITY DETECTION SYSTEM AND METHOD

(71) Applicant: DISH Wireless L.L.C., Englewood, CO (US)

(72) Inventors: Jimmy A. Pollard, JR., Boiling Springs, SC (US); Zachary Morrison, Greer, SC (US); John Leonard Pye, Inman, SC (US); Michael Joshua Horne, Greer, SC (US); Dillin Moore, Travelers Rest, SC (US)

(21) Appl. No.: 18/815,620

(22) Filed: Aug. 26, 2024

(51) Int. Cl. B65H 63/06; B65H 51/14; G01N 21/952

(52) U.S. Cl. CPC B65H 63/06; B65H 51/14; G01N 21/952; B65H 2701/34

(57) ABSTRACT

A system for cable abnormality detection is disclosed. The system includes a laser sensor measurement system for measuring a cable diameter and insulator jacket coating thickness of a cable and a guide assembly for guiding entry of the cable through the laser sensor measurement system. The system further includes a control system with a memory and a processor that executes computer-executable instructions and causes the processor to: measure the cable diameter with respect to upper limits of the cable diameter; determine that the cable diameter is outside of the upper limits using the cable diameter measurements and cable parameter tolerances; and initiate a signal to stop the cable from advancing, in response to determining that the cable diameter is outside of the upper limits.

### BACKGROUND

In the field of cellular networks, such as 5G and 6G networks, Open RAN networks are being embraced, which results in more cloud-based infrastructure being produced. As such, more unique cabinet structures are being used that result in custom cabinet building. Accordingly, many custom cabinets are being produced that are configured to work with components, such as cables of specific size parameters. Thus, if cables are being produced with insulation layers that are outside of tolerance parameters, these “out of tolerance” cable parameters may result in damage to the systems that the cables are configured to interact with. Such systems include wire-cutting and stripping machines that can have their belts damaged or destroyed if “out of tolerance” cables jam the guide tubes of these wire-cutting and stripping machines.

Additionally, even outside of the field of cellular networks, cable abnormality presents challenges and potential for resulting damage whenever cable harness assemblies are employed. In the past, many cables used in open environments with their parameters being outside of tolerance may have gone unnoticed. However, in today's technological increasing environment, greater customization and tolerance control has led to the realization that many cables are being produced having insulation layers that are out of tolerance. When insulation layers are out of tolerance on the upper limit, this can cause machinery to jam due the cables not fitting within their intended locations. When insulation layers are out of tolerance on the lower limit, this can cause fires or other electrical damage due the exposure of the raw wire with the cable, particularly in high voltage situations.

Unfortunately, attempted solutions have not satisfactorily addressed the issues described above. There is a continuing need for a system that provides increased detection and remediation techniques for identifying “out of tolerance” cables and prevents system damage resulting therefrom. The present disclosure addresses these and other needs.

### BRIEF SUMMARY

The present disclosure relates generally to a cable abnormality detection system, and more particularly, but not exclusively, to a cable abnormality detection system that identifies cable size variations, which may be detrimental to a system employing the cable. Specifically, the present disclosure is directed towards a cable abnormality detection system. The system includes a laser sensor measurement system, a roller assembly, a measurement system mounting bracket, and a control system with a memory and a processor. The laser sensor measurement system measures a cable diameter and insulator jacket coating thickness of a cable. The roller assembly guides entry of the cable through the laser sensor measurement system. The measurement system mounting bracket is used to secure the laser sensor measurement system and the roller assembly. The system includes a memory that stores computer-executable instructions; and a processor that executes the computer-executable instructions that cause the processor to: obtain upper limit tolerance requirements for the cable; compare the cable diameter with respect to upper limit tolerance requirements of the cable diameter; determine that the cable diameter is outside of upper limit tolerance requirements of the cable diameter; and stop the cable from running through a wire-cutting machine.

In some embodiments of the cable abnormality detection system, the memory includes further computer-executable instructions that cause the processor to: obtain lower limit measurements for the cable; determine that the cable diameter is outside of the lower limits; and initiate a remedial action in response to the outside of the lower limits detection. In another aspect of some embodiments, the remedial action is stopping the cable from running through the wire-cutting machine. In still another aspect of some embodiments, the remedial action is sending an alert regarding the outside of the lower limits detection. In yet another aspect of some embodiments, the memory includes further computer-executable instructions that cause the processor to initiate a remedial action in response to the outside of the upper limits detection. In one such embodiment, the remedial action is sending an alert regarding the outside of the upper limits detection.

In one or more embodiments, the cable abnormality detection system is operatively associated with a wire-cutting machine. The wire-cutting machine includes guide tubes through which a cable to be cut passes. Additionally, the wire-cutting machine further includes a belt system for pulling the cable off a cable reel, through the laser sensor measurement system, and through the guide tubes of the wire-cutting machine.

In another aspect of some embodiments, the memory includes further computer-executable instructions that further cause the processor to: obtain wire core measurements for the cable and the upper and lower limits of the insulator jacket coating thickness; determine the insulator jacket coating thickness of the cable using the cable diameter and the wire core measurements for the cable; detect when the insulator jacket coating thickness is outside of the upper limits or the lower limits; and initiate a remedial action in response to the detection of the insulator jacket coating thickness being outside of the upper or lower limits. In still another aspect of some embodiments, the laser sensor measurement system includes two or more sensors.

In one or more embodiments, methods for cable abnormality detection are described. Some such methods include: obtaining upper limit tolerance requirements for a diameter of a cable; detecting a presence of the cable in a laser sensor measurement system; measuring a cable diameter of the cable using the laser sensor measurement system while the cable is being guided through the laser sensor measurement system; determining, using one or more processors, when the measured cable diameter is outside of the upper limit tolerance requirements of the cable diameter; and sending, using one or more processors, a signal to stop the cable from advancing.

In some embodiments, the method for cable abnormality detection further includes: obtaining lower limit measurements for the cable; detecting when the cable diameter is outside of the lower limits; and initiating a remedial action in response to the outside of the lower limits detection. In another aspect of some embodiments, the remedial action is stopping the cable from running through the wire-cutting machine. In still another aspect of some embodiments, the remedial action is sending an alert regarding the outside of the lower limits detection. In yet another aspect of some embodiments, the method for cable abnormality detection further includes initiating a remedial action in response to the outside of the upper limits detection. Further, in another aspect of some embodiments, the remedial action is sending an alert regarding the outside of the upper limits detection.

In one or more embodiments of the cable abnormality detection method, the cable abnormality detection system is operatively associated with a wire-cutting machine. The wire-cutting machine includes guide tubes through which a cable to be cut passes. The wire-cutting machine further includes a belt system for pulling the cable off a cable reel, through the laser sensor measurement system, and through the guide tubes of the wire-cutting machine. In another aspect of some embodiments, the method for cable abnormality detection further includes: obtaining wire core measurements for the cable and the upper and lower limits of the insulator jacket coating thickness; measuring, using the laser sensor measurement system, the insulator jacket coating thickness of the cable using the cable diameter and the wire core measurements for the cable; detecting when the insulator jacket coating thickness is outside of the upper limits or the lower limits; and initiating a remedial action in response to the detection of the insulator jacket coating thickness being outside of the upper or lower limits. In still another aspect of some embodiments, the remedial action is sending a signal to stop the cable from running through the wire-cutting machine. In yet another aspect of some embodiments, the remedial action is sending an alert regarding the outside of the upper or lower limits detection.

In other embodiments, a cable abnormality detection system is described. The system includes a laser sensor measurement system, a guide assembly, a memory and a processor. The laser sensor measurement system measures a cable diameter and insulator jacket coating thickness of a cable. The guide assembly guides entry of the cable through the laser sensor measurement system. The system includes a memory that stores computer-executable instructions; and a processor that executes the computer-executable instructions that cause the processor to: measure the cable diameter with respect to upper limit tolerance requirements of the cable diameter; determine that the cable diameter is outside of the upper limit tolerance requirements using the cable diameter measurements and cable parameter tolerances; and initiate a signal to commence a remedial action, in response to determining that the cable diameter is outside of the upper limits.

In one or more embodiments, the cable abnormality detection system is operatively associated with a wire-cutting machine. The wire-cutting machine includes guide tubes through which a cable to be cut passes. Additionally, the wire-cutting machine further includes a belt system for pulling the cable off a cable reel, through the laser sensor measurement system, and through the guide tubes of the wire-cutting machine.

In another aspect of some embodiments, the memory includes further computer-executable instructions that further cause the processor to: obtain wire core measurements for the cable and the upper and lower limits of the insulator jacket coating thickness; determine the insulator jacket coating thickness of the cable using the cable diameter and the wire core measurements for the cable; detect when the insulator jacket coating thickness is outside of the upper limits or the lower limits; and initiate a remedial action in response to the detection of the insulator jacket coating thickness being outside of the upper or lower limits. In still another aspect of some embodiments, the laser sensor measurement system includes two or more sensors.

These features with other technological improvements, which will become subsequently apparent, reside in the details of construction and operation as more fully described hereafter and claimed, reference being had to the accompanying drawings forming a part hereof.

### BRIEF DESCRIPTION OF THE DRAWINGS

The present application will be more fully understood by reference to the following figures, which are for illustrative purposes only. The figures are not necessarily drawn to scale and elements of similar structures or functions are generally represented by like reference numerals for illustrative purposes throughout the figures. The figures are only intended to facilitate the description of the various embodiments described herein. The figures do not describe every aspect of the teachings disclosed herein and do not limit the scope of the claims.

FIG. 1 illustrates an elevated perspective view of a cable abnormality detection system, in accordance with embodiments described herein.

FIG. 2 illustrates a side perspective view of a cable abnormality detection system, in accordance with embodiments described herein.

FIG. 3 illustrates a perspective view of a cable abnormality detection system with a cable being fed through the roller assembly and laser sensor measurement system.

FIG. 4 illustrates a perspective view of a cable being fed through a belt assembly and wire cutting machine after successfully passing through the cable abnormality detection system.

FIG. 5 illustrates a wiring diagram of a cable abnormality detection system.

FIG. 6 illustrates a logical flow diagram of a cable abnormality detection method, in accordance with embodiments described herein.

FIG. 7 shows a system block diagram that depicts one implementation of computing systems for employing embodiments described herein.

### DETAILED DESCRIPTION

Persons of ordinary skill in the art will understand that the present disclosure is illustrative only and not in any way limiting. Other embodiments and various combinations of the presently disclosed system and method readily suggest themselves to such skilled persons having the assistance of this disclosure.

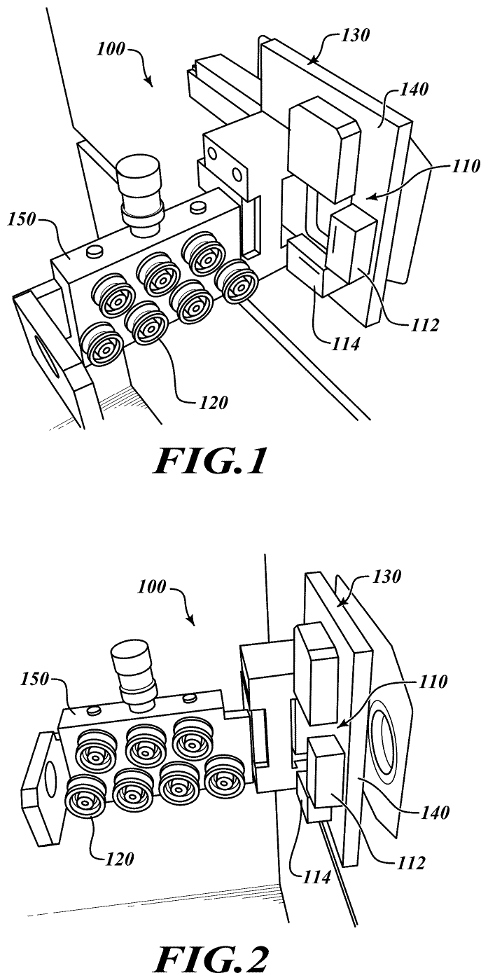

Each of the features and teachings disclosed herein can be utilized separately or in conjunction with other features and teachings to provide a cable abnormality detection system. Representative examples utilizing many of these additional features and teachings, both separately and in combination, are described in further detail with reference to attached FIGS. 1-5. This detailed description is intended to teach a person skilled in the art further details for practicing aspects of the present teachings and is not intended to limit the scope of the claims. Therefore, combinations of features disclosed above in the detailed description may not be necessary to practice the teachings in the broadest sense, and are instead taught merely to describe particularly representative examples of the present teachings.

In the description below, for purposes of explanation only, specific nomenclature is set forth to provide a thorough understanding of the present system and method. However, it will be apparent to one skilled in the art that these specific details are not required to practice the teachings of the present system and method.

Throughout the specification, claims, and drawings, the following terms take the meaning explicitly associated herein, unless the context clearly dictates otherwise. The term “herein” refers to the specification, claims, and drawings associated with the current application. The phrases “in one embodiment,” “in another embodiment,” “in various embodiments,” “in some embodiments,” “in other embodiments,” and other variations thereof refer to one or more features, structures, functions, limitations, or characteristics of the present disclosure, and are not limited to the same or different embodiments unless the context clearly dictates otherwise. As used herein, the term “or” is an inclusive “or” operator, and is equivalent to the phrases “A or B, or both” or “A or B or C, or any combination thereof,” and lists with additional elements are similarly treated. The term “based on” is not exclusive and allows for being based on additional features, functions, aspects, or limitations not described, unless the context clearly dictates otherwise. In addition, throughout the specification, the meaning of “a,” “an,” and “the” include singular and plural references.

Some portions of the detailed descriptions herein are presented in terms of algorithms and symbolic representations of operations on data bits within a computer memory. These algorithmic descriptions and representations are the means used by those skilled in the data processing arts to most effectively convey the substance of their work to others skilled in the art. An algorithm, as described herein, is a sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the below discussion, it is appreciated that throughout the description, discussions utilizing terms such as “processing,” “computing,” “calculating,” “determining,” “displaying,” “configuring,” or the like, refer to the actions and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present application also relates to an apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but not limited to, any type of disk, including floppy disks, optical disks, CD-ROMs, and magnetic-optical disks, read-only memories (ROMs), random access memories (RAMs), EPROMS, EEPROMs, magnetic or optical cards, or any type of media suitable for storing electronic instructions, and each coupled to a computer system bus.

Moreover, the various features of the representative examples and the dependent claims may be combined in ways that are not specifically and explicitly enumerated in order to provide additional useful embodiments of the present teachings. It is also expressly noted that all value ranges or indications of groups of entities disclose every possible intermediate value or intermediate entity for the purpose of original disclosure, as well as for the purpose of restricting the claimed subject matter. It is also expressly noted that the dimensions and the shapes of the components shown in the figures are designed to help to understand how the present teachings are practiced, but not intended to limit the dimensions and the shapes shown in the examples.

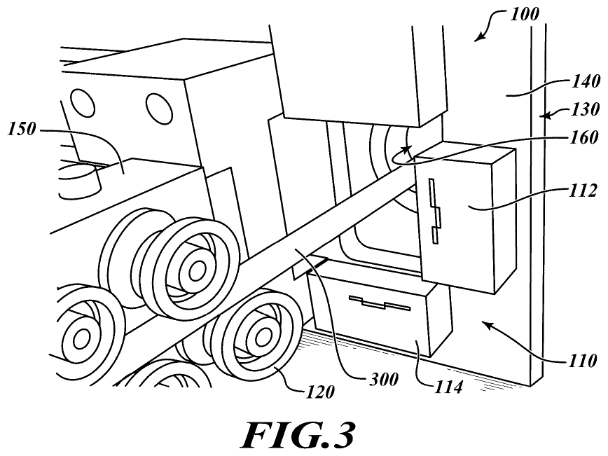

Referring now to FIGS. 1-5, one embodiment of a cable abnormality detection system is shown. FIGS. 1 and 2 show a cable abnormality detection system 100 that identifies cable size variations that extend outside tolerance limits. Significantly, a cable 300 (as shown in FIG. 3) that extends past the upper tolerance limits may cause damage to equipment or a system with which the cable was designed to interact. Alternatively, a cable 300 that extends below the lower tolerance limits may cause damage to surrounding equipment, systems, and the environment due to electrical shielding failure and potential resulting fire hazards. Specifically, one or more embodiments of a cable abnormality detection system 100 includes a laser sensor measurement system 110, a roller assembly 120, a measurement system mounting bracket 130, and a control system 700 (shown in FIG. 7) with a memory 732 and a processor 734 (shown in FIG. 7).

In some embodiments, the laser sensor measurement system 110 measures a cable diameter and insulator jacket coating thickness of a cable 300. The roller assembly 120 guides entry of the cable 300 through the laser sensor measurement system 110. The measurement system mounting bracket 130 is used to secure the laser sensor measurement system 110 and the roller assembly 120 together in alignment with each other. In some embodiments, there may additionally be a cable detector (not shown) that detects the presence of the cable 300 in the cable abnormality detection system 100; however, in other embodiments of the cable abnormality detection system 100 this component is not necessary since readings from the laser sensor measurement system 110 are sufficient to determine that the cable 300 is present in the system.

In some embodiments of the cable abnormality detection system 100, as shown in FIGS. 1 and 2, the laser sensor measurement system 110 is used to measure a diameter of the cable 300. In some embodiments, the laser sensor measurement system 110 includes a vertical sensor 112 and a horizontal sensor 114. While various different types of sensor systems may be used, in one embodiment the laser sensor measurement system 110 employs Charge-Coupled Device (CCD) sensors and visible light semiconductor lasers. Other types of sensor systems that could be used include, by way of example only, and not by way of limitation, camera sensors with image analysis, rollers with pressure sensors, and the like. In one specific non-limiting example, the laser sensor measurement system 110 uses a laser with a wavelength approximately 660 nm. In another aspect of a specific non-limiting example, optical axis alignment indicators are employed on both the transmitter and the receiver of the sensors. In some embodiments, the laser sensor measurement system 110 includes two or more sensors so that the diameter of the cable can be measured at different radial positions. For example, in one embodiment shown in FIG. 3, a cross-section of the cable 300 is measured vertically along a y-axis by a first set of sensors, and a cross-section of the cable 300 is measured horizontally along an x-axis by a second set of sensors, since the cable could be properly proportioned in one dimension and improperly proportioned in another dimension.

In some embodiments of the cable abnormality detection system 100, if a sensor in the laser sensor measurement system 110 detects a very small region that exceeds the upper end of the tolerance limitation, the system identify the cable as improperly proportioned and halts the progression of the cable immediately. In other embodiments of the cable abnormality detection system 100, a sensor in the laser sensor measurement system 110 may be required to detect a region that exceeds the upper end of the tolerance limitation over a predefined length (e.g., one or two cm) in order for the system to identify the cable as improperly proportioned, and halt the progression of the cable.

As will be described in further detail below, in some embodiments of the cable abnormality detection system 100, only the cable diameter is used to make a determination as to whether the cable passes the inspection and is allowed to proceed. In other embodiments of the cable abnormality detection system 100, the cable diameter measurement is used in conjunction with other parameter data, such as the diameter of the cable wire core, to calculate the insulator jacket coating thickness of the cable 300, and make a determination as to whether the insulator thickness of the cable 300 passes the inspection and is allowed to proceed. Since the insulator jacket coating of a cable is typically a plastic that is formed through an extrusion process, variation in insulator thickness is much more common large in magnitude than any variation in the diameter of the wire core which is metal.

Referring now to the roller assembly 120 of the cable abnormality detection system 100, the roller assembly 120 guides the entry of the cable 300 through the laser sensor measurement system 110. In the embodiment of the roller assembly 120 that is most clearly shown in FIGS. 1 and 2, a first series of rollers are positioned to engage the top of the cable 300 and a second series of rollers are positioned to engage the bottom of the cable 300. In the embodiment shown in FIGS. 1 and 2, the first series of rollers includes four rollers that are positioned to engage the top of the cable 300 and a second series of rollers includes three rollers that are positioned to engage the bottom of the cable 300. In other embodiments, larger or smaller number of rollers may be used as necessities by the parameters of the cable 300.

FIG. 3 most clearly illustrates the cable 300 traveling between the rollers that are positioned to engage the top of the cable 300 and rollers that are positioned to engage the bottom of the cable 300 and then continue on to the laser sensor measurement system 110. In some embodiments of the cable abnormality detection system 100 the roller assembly 120 is powered and drives the movement of the cable 300 through the roller assembly. However, in other embodiments, the roller assembly 120 is not powered, but rather is passive, and simply guides the movement of the cable 300 through the roller assembly, while another system (not shown in FIGS. 1-3) controls the speed of the movement of the cable through the cable abnormality detection system 100. In still another embodiment of the cable abnormality detection system 100, the roller assembly 120 is replaced with another non-roller based system that guides the cable through the laser sensor measurement system 110. In yet another embodiment of the cable abnormality detection system 100, there is no equivalent component to the roller assembly 120 that is part of the cable abnormality detection system 100, but rather a component external to the cable abnormality detection system 100 performs the functions of the roller assembly 120.

Referring now to the measurement system mounting bracket 130 of the cable abnormality detection system 100, as shown in FIGS. 1 and 2, the laser sensor measurement system 110 and the roller assembly 120 are mounted on the measurement system mounting bracket 130. In some embodiments, the measurement system mounting bracket 130 includes a flat vertical panel 140 upon which the sensor of the laser sensor measurement system 110 is mounted. As shown in FIG. 3, the measurement system mounting bracket 130 also includes an opening 160 in the flat vertical panel 140 which the cable 300 passes through. Additionally, the measurement system mounting bracket 130 further includes a roller assembly mount 150 that extends perpendicularly from the flat vertical panel 140 of the measurement system mounting bracket 130. Specifically, in one or more embodiments, the roller assembly 120 is attached to the roller assembly mount 150 of the measurement system mounting bracket 130. In other embodiments of the cable abnormality detection system 100, various other configurations of the measurement system mounting bracket 130 may be employed.

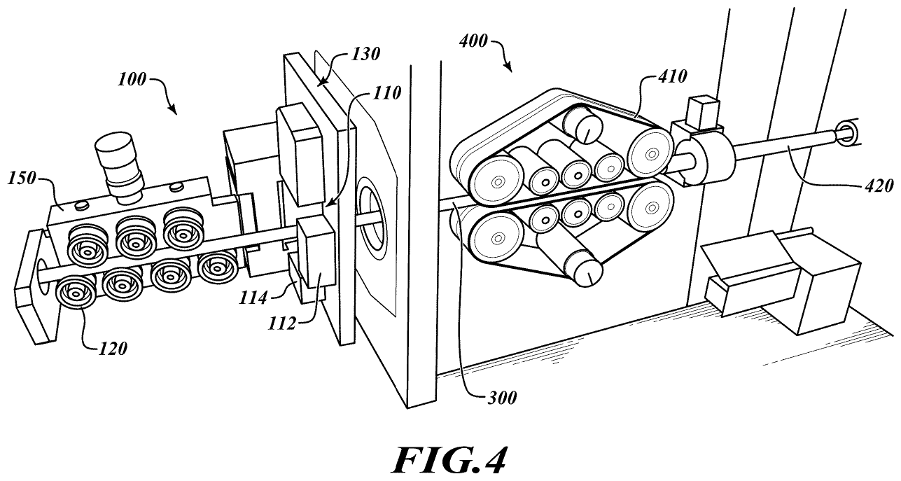

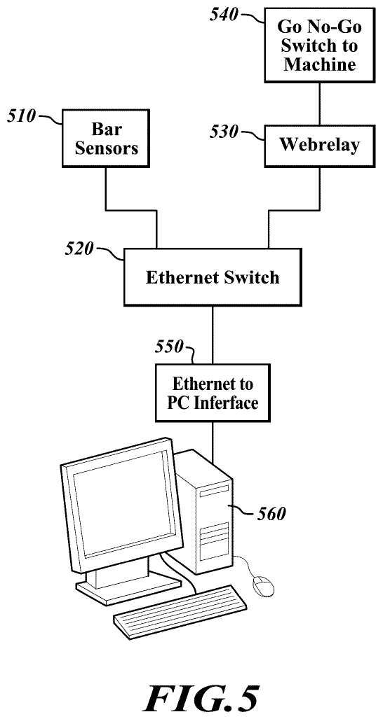

As shown in FIG. 4, such a cable processing machine 400 includes a belt assembly 410 that drives the cable 300. The cable processing machine 400 also includes guide tubes 420 through which the cable 300 is driven. In some embodiments, the cable abnormality detection system 100 is operatively associated with a cable processing machine 400 (e.g., wire-cutting machine). The cable processing machine 400 includes guide tubes 420 through which the cable 300 to be cut passes. In some embodiments, the belt assembly 410 of the cable processing machine 400 pulls the cable 300 off a cable reel (not shown), through the laser sensor measurement system 110, and through the guide tubes 420 of the cable processing machine 400. Without the cable abnormality detection system 100 to detect a cable with a diameter that is over the tolerance limit, the cable may jam the guide tubes 420 of the cable processing machine 400, which have tight tolerances, and then burn out the belt assembly 410 as it tries to drive a cable 300 that doesn't fit through the belt assembly 410.

Referring now to FIG. 5, a wiring diagram is shown for one embodiment of a cable abnormality detection system 100. In the embodiment shown in FIG. 5, the cable abnormality detection system 100 includes a bar sensor 510, an Ethernet switch 520, a web relay 530, a Go No-Go switch 540, and an Ethernet to PC interface 550. The bar sensor 510 is part of the laser sensor measurement system 110 described above with respect to FIGS. 1 and 2. The bar sensor 510 connects to the Ethernet switch 520. The Ethernet switch 520 is also connected to the Go No-Go switch 540 to cable processing machine 400 (shown in FIG. 4), for example, via the web relay 530. Additionally, the Ethernet switch 520 is also connected to the Ethernet to PC interface 550 of the PC 560. Accordingly, in this manner, cable diameter information obtained by the bar sensor 510 of the laser sensor measurement system 110 is able to be transmitted to the PC 560 for processing via the Ethernet switch 520 and the Ethernet to PC interface 550. Then the PC 560 transmits signals to the Go No-Go switch 540, via the Ethernet to PC interface 550, the Ethernet switch 520, and the web relay 530. Notably, in other embodiments of the cable abnormality detection system 100, different wiring arrangements may be implemented that still result in the same ultimate transmission of information, and which are within the skill of one of ordinary skill in the art.

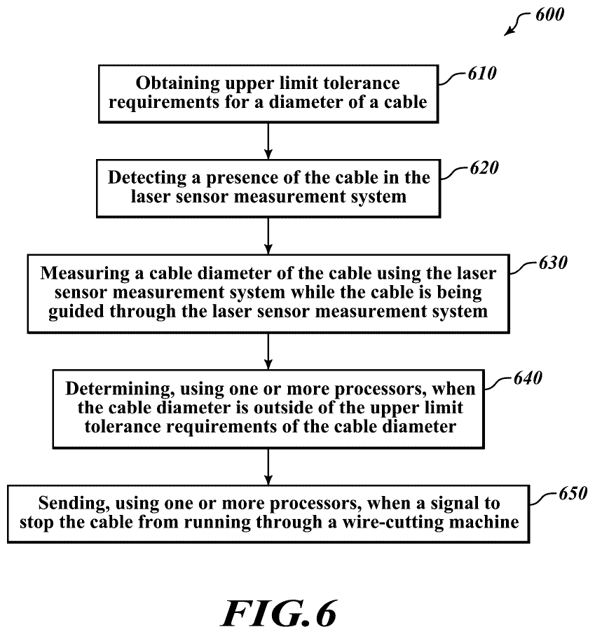

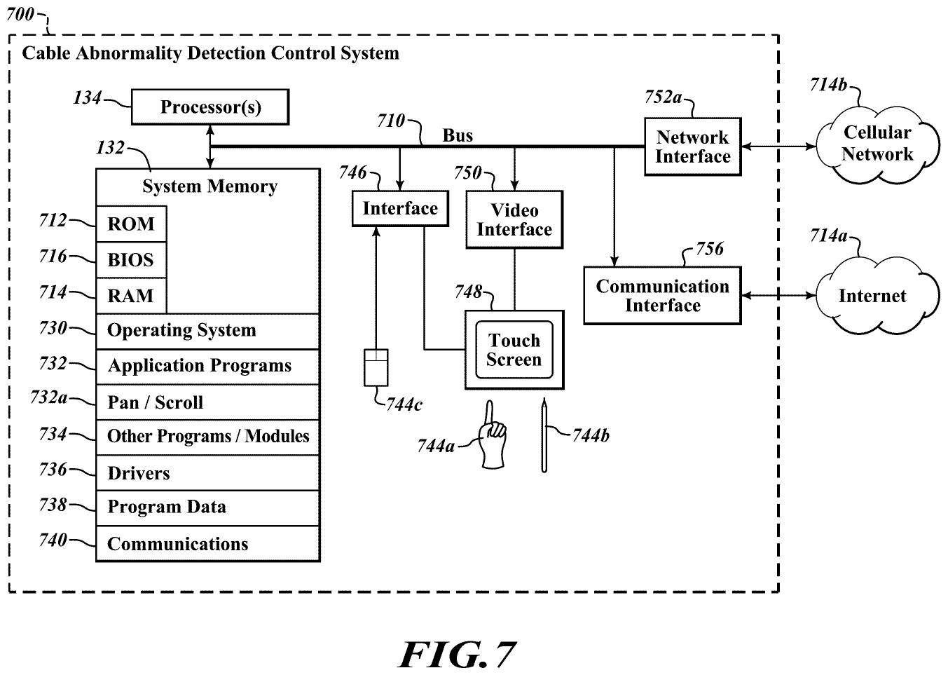

FIG. 6 is a logic diagram showing a cable abnormality detection method 600. As shown in FIG. 6, at operation 610, the method includes obtaining upper limit tolerance requirements for a diameter of a cable. At operation 620, the method includes detecting a presence of the cable in a laser sensor measurement system. At operation 630, the method includes measuring a cable diameter of the cable using the laser sensor measurement system while the cable is being guided through the laser sensor measurement system. At operation 640, the method includes determining, using one or more processors, when the measured cable diameter is outside of the upper limit tolerance requirements of the cable diameter. At operation 650, the method includes sending, using one or more processors, a signal to stop the cable from running through a wire-cutting machine.

Referring now to the control system 700 (shown in FIG. 7) of the cable abnormality detection system 100, the control system 700 includes the memory 732 and the processor 734. In some embodiments, the memory 732 contains or is sent information such as the upper and lower tolerances of the cable 300 in diameter. Additionally, in another aspect of some embodiments, the memory 732 contains or is sent additional information such as the upper and lower tolerances of the wire core of the cable 300 in diameter, as well as the upper and lower tolerances of the insulator jacket coating of the cable 300 in thickness. When the laser sensor measurement system 110 begins measuring the diameter of the cable 300 in the cable abnormality detection system 100, this information is also stored in the memory 732. The processor 734 of the control system 700 may then be used to compare the cable diameter with respect to the upper and lower tolerance limits of the cable diameter that are stored in the memory 732.

If the control system 700 determines that the cable diameter is outside of the upper limits or the lower limits for the cable tolerances, then one or more remedial actions may be taken. In one embodiment, the remedial action is sending a signal to stop the advancement or movement of the cable through the system. In particular, it may be urgent to stop the cable from travelling immediately into another machine, such as a wire cutting and stripping machine, in which an oversized cable could damage the machine. For example, one standard machine that is used in cable processing is the Schleuniger wire-cutting and stripping machine.

In another embodiment, the remedial action is sending a signal to alter the path of the cable and send the cable to a “no pass” location instead of sending the cable to a “pass” location. For example, when the cable is identified as under the acceptable tolerance, there may not be an immediate danger of damaging another system; however, there may be an electrical or fire danger if that cable is actually put into use. Thus, sending the portion of the cable that is outside of the acceptable tolerance to a “no pass” location instead of to a “pass” location may be sufficient. Additionally, in still another embodiment of the cable abnormality detection system 100, the remedial actions may include sending an alert or other message regarding the cable 300 being outside of the upper limits or the lower limits for the cable tolerances. Notably, in some embodiments of the cable abnormality detection system 100, the system only checks for upper limit tolerances that are exceeded by the cable diameter, while in other embodiments of the cable abnormality detection system 100, the system only checks for lower limit tolerances with respect to unacceptable cable diameter variation. In still other embodiments of the cable abnormality detection system 100, the system checks for both upper limit tolerances that are exceeded by the cable diameter and lower limit tolerances that are violated by low cable diameter.

As described above, in some embodiments of the cable abnormality detection system 100, only the cable diameter is used to make a determination as to whether the cable passes the inspection and is allowed to proceed. However, in other embodiments of the cable abnormality detection system 100, the cable diameter measurement is used in conjunction with other parameter data, such as the diameter of the cable wire core, to calculate the insulator jacket coating thickness of the cable 300. The variation in cable diameter is typical due to variation in the plastic insulator thickness, and not variation in the diameter of the metal wire core of the cable. Thus, in such embodiments, the system calculates insulator jacket coating thickness and makes a determination as to whether the insulator thickness of the cable 300 passes the inspection and is allowed to proceed.

Since the memory 732 contains information on the upper and lower tolerances of the wire core of the cable 300 in diameter, as well as the upper and lower tolerances of the insulator jacket coating of the cable 300 in thickness, the processor 734 of the control system 700 may be used to compare the insulator jacket coating thickness with respect to the upper and lower tolerance limits of the insulator jacket coating thickness that are stored in the memory 732 (after the laser sensor measurement system 110 measures the diameter of the cable 300). If the control system 700 determines that the insulator jacket coating thickness is outside of the upper limits or the lower limits for the cable tolerances, then one or more remedial actions may be taken. In one embodiment, the remedial action is sending a signal to stop the advancement or movement of the cable through the system. In another embodiment, the remedial action is sending a signal to alter the path of the cable and send the cable to a “no pass” location instead of sending the cable to a “pass” location when the insulator jacket coating thickness is out of tolerance. Additionally, in still another embodiment of the cable abnormality detection system 100, the remedial actions may include sending an alert or other message regarding the insulator jacket coating thickness of the cable 300 being outside of the upper limits or the lower limits for the cable tolerances.

Notably, in some embodiments of the cable abnormality detection system 100, the system only checks for upper limit tolerances that are exceeded by the insulator jacket coating thickness of the cable 300, while in other embodiments of the cable abnormality detection system 100, the system only checks for lower limit tolerances with respect to unacceptable insulator jacket coating thickness variation. In still other embodiments of the cable abnormality detection system 100, the system checks for both upper limit tolerances that are exceeded by the insulator jacket coating thickness and lower limit tolerances that are violated by low insulator jacket coating thickness.

FIG. 7 shows a processor-based device suitable for implementing the cable abnormality detection system. Although not required, some portion of the implementations will be described in the general context of processor-executable instructions or logic, such as program application modules, objects, or macros being executed by one or more processors. Those skilled in the relevant art will appreciate that the described implementations, as well as other implementations, can be practiced with various processor-based system configurations, including handheld devices, such as smartphones and tablet computers, wearable devices, multiprocessor systems, microprocessor-based or programmable consumer electronics, personal computers (PCs), network PCs, minicomputers, mainframe computers, and the like.

In the system for cable abnormality detection system, the processor-based device may include one or more processors 734, a system memory 732 and a system bus 710 that couples various system components including the system memory 732 to the processor(s) 734. The processor-based device will, at times, be referred to in the singular herein, but this is not intended to limit the implementations to a single system, since in certain implementations, there will be more than one system or other networked computing devices involved. Non-limiting examples of commercially available systems include, but are not limited to, ARM processors from a variety of manufacturers, Core microprocessors from Intel Corporation, U.S.A., PowerPC microprocessors from IBM, Sparc microprocessors from Sun Microsystems, Inc., PA-RISC series microprocessors from Hewlett-Packard Company, and 68xxx series microprocessors from Motorola Corporation. The system memory 732 may be located on premises or it may be cloud-based.

The processor(s) 734 in the processor-based devices of the cable abnormality detection system may be any logic processing unit, such as one or more central processing units (CPUs), microprocessors, digital signal processors (DSPs), application-specific integrated circuits (ASICs), field programmable gate arrays (FPGAs), and the like. Unless described otherwise, the construction and operation of the various blocks shown in FIG. 5 are of conventional design. As a result, such blocks need not be described in further detail herein, as they will be understood by those skilled in the relevant art.

The system bus 710 in the processor-based devices of the cable abnormality detection system can employ any known bus structures or architectures, including a memory bus with a memory controller, a peripheral bus, and a local bus. The system memory 732 includes read-only memory (ROM) 712 and random access memory (RAM) 714. A basic input/output system (BIOS) 716, which can form part of the ROM 712, contains basic routines that help transfer information between elements within the processor-based device, such as during start-up. Some implementations may employ separate buses for data, instructions and power.

The processor-based device of the cable abnormality detection system may also include one or more solid state memories; for instance, a flash memory or solid state drive (SSD), which provides nonvolatile storage of computer-readable instructions, data structures, program modules and other data for the processor-based device. Although not depicted, the processor-based device can employ other non-transitory computer- or processor-readable media, for example, a hard disk drive, an optical disk drive, or a memory card media drive.

Program modules in the processor-based devices of the cable abnormality detection system can be stored in the system memory 732, such as an operating system 730, one or more application programs 732, other programs or modules 734, drivers 736 and program data 738.

The application programs 732 may, for example, include panning/scrolling logic 732a. Such panning/scrolling logic may include, but is not limited to, logic that determines when and/or where a pointer (e.g., finger, stylus, cursor) enters a user interface element that includes a region having a central portion and at least one margin. Such panning/scrolling logic may include, but is not limited to, logic that determines a direction and a rate at which at least one element of the user interface element should appear to move, and causes updating of a display to cause the at least one element to appear to move in the determined direction at the determined rate. The panning/scrolling logic 732a may, for example, be stored as one or more executable instructions. The panning/scrolling logic 732a may include processor and/or machine executable logic or instructions to generate user interface objects using data that characterizes movement of a pointer, for example, data from a touch-sensitive display or from a computer mouse or trackball, or another user interface device.

The system memory 732 in the processor-based devices of the cable abnormality detection system may also include communications programs 740, for example, a server and/or a Web client or browser for permitting the processor-based device to access and exchange data with other systems such as user computing systems, websites on the Internet, corporate intranets, or other networks as described below. The communications program 740 in the depicted implementation is markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers and/or Web clients or browsers are commercially available such as those from Mozilla Corporation of California and Microsoft of Washington.

While shown in FIG. 7 as being stored in the system memory 732, operating system 730, application programs 732, other programs/modules 734, drivers 736, program data 738 and server and/or browser can be stored on any other of a large variety of non-transitory processor-readable media (e.g., hard disk drive, optical disk drive, SSD and/or flash memory).

A user of a processor-based device in the cable abnormality detection system can enter commands and information via a pointer, for example, through input devices such as a touch screen 748 via a finger 744a, stylus 744b, or via a computer mouse or trackball 744c which controls a cursor. Other input devices can include a microphone, joystick, game pad, tablet, scanner, biometric scanning device, and the like. These and other input devices (i.e., I/O devices) are connected to the processor(s) 734 through an interface 746 such as a touch-screen controller and/or a universal serial bus (USB) interface that couples user input to the system bus 710, although other interfaces such as a parallel port, a game port or a wireless interface or a serial port may be used. The touch screen 748 can be coupled to the system bus 710 via a video interface 750, such as a video adapter to receive image data or image information for display via the touch screen 748. Although not shown, the processor-based device can include other output devices, such as speakers, vibrator, haptic actuator or haptic engine, and the like.

The processor-based devices of the cable abnormality detection system operate in a networked environment using one or more of the logical connections to communicate with one or more remote computers, servers and/or devices via one or more communications channels, for example, one or more networks 714a, 714b. These logical connections may facilitate any known method of permitting computers to communicate, such as through one or more LANs and/or WANs, such as the Internet, and/or cellular communication networks. Such networking environments are well known in wired and wireless enterprise-wide computer networks, intranets, extranets, the Internet, and other types of communication networks including telecommunication networks, cellular networks, paging networks, and other mobile networks.

When used in a networking environment, the processor-based devices of the cable abnormality detection system may include one or more network, wired or wireless communications interfaces 752a, 756 (e.g., network interface controllers, cellular radios, Wi-Fi radios, Bluetooth radios) for establishing communications over the network, for instance, the Internet 714a or cellular network 714b.

In a networked environment, program modules, application programs, or data, or portions thereof, can be stored in a server computing system (not shown). Those skilled in the relevant art will recognize that the network connections shown in FIG. 5 are only some examples of ways of establishing communications between computers, and other connections may be used, including wirelessly.

For convenience, the processor(s) 734, system memory 732, and network and communications interfaces 752a, 756 are illustrated as communicably coupled to each other via the system bus 710, thereby providing connectivity between the above-described components. In alternative implementations of the processor-based device, the above-described components may be communicably coupled in a different manner than illustrated in FIG. 5. For example, one or more of the above-described components may be directly coupled to other components, or may be coupled to each other, via intermediary components (not shown). In some implementations, system bus 710 is omitted, and the components are coupled directly to each other using suitable connections.

Throughout this specification and the appended claims the term “communicative” as in “communicative pathway,” “communicative coupling,” and in variants such as “communicatively coupled,” is generally used to refer to any engineered arrangement for transferring and/or exchanging information. Exemplary communicative pathways include, but are not limited to, electrically conductive pathways (e.g., electrically conductive wires, electrically conductive traces), magnetic pathways (e.g., magnetic media), one or more communicative link(s) through one or more wireless communication protocol(s), and/or optical pathways (e.g., optical fiber), and exemplary communicative couplings include, but are not limited to, electrical couplings, magnetic couplings, wireless couplings, and/or optical couplings.

Throughout this specification and the appended claims, infinitive verb forms are often used. Examples include, without limitation: “to detect,” “to provide,” “to transmit,” “to communicate,” “to process,” “to route,” and the like. Unless the specific context requires otherwise, such infinitive verb forms are used in an open, inclusive sense, that is as “to, at least, detect,” “to, at least, provide,” “to, at least, transmit,” and so on.

The above description of illustrated implementations, including what is described in the Abstract, is not intended to be exhaustive or to limit the implementations to the precise forms disclosed. Although specific implementations and examples are described herein for illustrative purposes, various equivalent modifications can be made without departing from the spirit and scope of the disclosure, as will be recognized by those skilled in the relevant art. The teachings provided herein of the various implementations can be applied to other portable and/or wearable electronic devices, not necessarily the exemplary wearable electronic devices generally described above.

For instance, the foregoing detailed description has set forth various implementations of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one implementation, the present subject matter may be implemented via Application Specific Integrated Circuits (ASICs). However, those skilled in the art will recognize that the implementations disclosed herein, in whole or in part, can be equivalently implemented in standard integrated circuits, as one or more computer programs executed by one or more computers (e.g., as one or more programs running on one or more computer systems), as one or more programs executed by one or more controllers (e.g., microcontrollers), as one or more programs executed by one or more processors (e.g., microprocessors, central processing units, graphical processing units), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any processor-readable medium for use by, or in connection with, any processor-related system or method. In the context of this disclosure, a memory is a processor-readable medium that is an electronic, magnetic, optical, or other physical device or means that contains or stores a computer and/or processor program. Logic and/or the information can be embodied in any processor-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “non-transitory processor-readable medium” can be any element that can store the program associated with logic and/or information for use by, or in connection with, the instruction execution system, apparatus, and/or device. The processor-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or flash memory), a portable compact disc read-only memory (CD-ROM), digital tape, and other non-transitory media.

Operations of processes described herein can be performed in any suitable order unless otherwise indicated herein or otherwise clearly contradicted by context. The processes described herein (or variations and/or combinations thereof) are performed under the control of one or more computer systems configured with executable instructions and are implemented as code (e.g., executable instructions, one or more computer programs or one or more applications) executing collectively on one or more processors, by hardware or combinations thereof. In an embodiment, the code is stored on a computer-readable storage medium, for example, in the form of a computer program comprising a plurality of instructions executable by one or more processors. In an embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals.

In an embodiment, code (e.g., executable code or source code) is stored on a set of one or more non-transitory computer-readable storage media having stored thereon executable instructions that, when executed (i.e., as a result of being executed) by one or more processors of a computer system, cause the computer system to perform operations described herein. The set of non-transitory computer-readable storage media, in an embodiment, comprises multiple non-transitory computer-readable storage media, and one or more of individual non-transitory storage media of the multiple non-transitory computer-readable storage media lacks all of the code while the multiple non-transitory computer-readable storage media collectively store all of the code. In an embodiment, the executable instructions are executed such that different instructions are executed by different processors—for example, a non-transitory computer-readable storage medium stores instructions and a main CPU executes some of the instructions while a graphics processor unit executes other instructions. In an embodiment, different components of a computer system have separate processors, and different processors execute different subsets of the instructions.

Accordingly, in an embodiment, computer systems are configured to implement one or more services that singly or collectively perform operations of processes described herein, and such computer systems are configured with applicable hardware and/or software that enable the performance of the operations.

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure. All references, including publications, patent applications, and patents, cited herein are hereby incorporated by reference to the same extent as if each reference were individually and specifically indicated to be incorporated by reference and were set forth in its entirety herein.

1. A system for cable abnormality detection, the system comprising:
a laser sensor measurement system for measuring a cable diameter of a cable;
a roller assembly for guiding entry of the cable through the laser sensor measurement system;
a measurement system mounting bracket upon which the laser sensor measurement system and the roller assembly are operatively associated;
a memory that stores computer-executable instructions; and
a processor that executes the computer-executable instructions and causes the processor to:
obtain upper limit tolerance requirements for the cable;
compare the cable diameter with respect to upper limit tolerance requirements of the cable diameter;
determine that the cable diameter is outside of upper limit tolerance requirements of the cable diameter; and
stop the cable from running through a wire-cutting machine.

2. The system of claim 1, wherein the memory includes further computer-executable instructions that further cause the processor to:
obtain lower limit measurements for the cable;
detect that the cable diameter is outside of the lower limits; and
initiate a remedial action in response to the outside of the lower limits detection.

3. The system of claim 2, wherein the remedial action is stopping the cable from running through the wire-cutting machine.

4. The system of claim 2, wherein the remedial action is sending an alert regarding the outside of the lower limits detection.

5. The system of claim 1, wherein the memory includes further computer-executable instructions that further cause the processor to:
initiate a remedial action in response to the outside of the upper limits detection.

6. The system of claim 5, wherein the remedial action is sending an alert regarding the outside of the upper limits detection.

7. The system of claim 1, wherein the cable abnormality detection system is operatively associated with a wire-cutting machine, wherein the wire-cutting machine includes guide tubes through which a cable to be cut passes, and wherein the wire-cutting machine further includes a belt system for pulling the cable off a cable reel, through the laser sensor measurement system, and through the guide tubes of the wire-cutting machine.

8. The system of claim 1, wherein the memory includes further computer-executable instructions that further cause the processor to:
obtain wire core measurements for the cable and the upper and lower limits of the insulator jacket coating thickness;
determine the insulator jacket coating thickness of the cable using the cable diameter and the wire core measurements for the cable;
detect when the insulator jacket coating thickness is outside of the upper limits or the lower limits; and
initiate a remedial action in response to the detection of the insulator jacket coating thickness being outside of the upper or lower limits.

9. The system of claim 1, wherein the laser sensor measurement system includes two or more sensors.

10. A method of cable abnormality detection, the method comprising:
obtaining upper limit tolerance requirements for a diameter of a cable;
detecting a presence of the cable in a laser sensor measurement system;
measuring a cable diameter of the cable using the laser sensor measurement system while the cable is being guided through the laser sensor measurement system;
determining, using one or more processors, when the measured cable diameter is outside of the upper limit tolerance requirements of the cable diameter; and
sending, using one or more processors, a signal to stop the cable from advancing.

11. The method of claim 10, further comprising:
obtaining lower limit measurements for the cable;
detecting when the cable diameter is outside of the lower limits; and
initiating a remedial action in response to the outside of the lower limits detection.

12. The method of claim 11, wherein the remedial action is stopping the cable from running through the wire-cutting machine.

13. The method of claim 11, wherein the remedial action is sending an alert regarding the outside of the lower limits detection.

14. The method of claim 11, further comprising:
initiating a remedial action in response to the outside of the upper limits detection.

15. The method of claim 14, wherein the remedial action is sending an alert regarding the outside of the upper limits detection.

16. The method of claim 11, further comprising: operatively associating the laser sensor measurement system with a wire-cutting machine, wherein the wire-cutting machine includes guide tubes through which a cable to be cut passes, and wherein the wire-cutting machine further includes a belt system for pulling the cable off a cable reel, through the laser sensor measurement system, and through the guide tubes of the wire-cutting machine.

17. The method of claim 11, further comprising:
obtaining wire core measurements for the cable and the upper and lower limits of an insulator jacket coating thickness;
measuring, using the laser sensor measurement system, the insulator jacket coating thickness of the cable using the cable diameter and the wire core measurements for the cable;
detecting when the insulator jacket coating thickness is outside of the upper limits or the lower limits; and
initiating a remedial action in response to the detection of the insulator jacket coating thickness being outside of the upper or lower limits.

18. The method of claim 17, wherein the remedial action is sending a signal to stop the cable from running through the wire-cutting machine.

19. The method of claim 17, wherein the remedial action is sending an alert regarding the outside of the upper or lower limits detection.

20. A system for cable abnormality detection, the system comprising:
a laser sensor measurement system for measuring a cable diameter of a cable;
a guide assembly for guiding entry of the cable through the laser sensor measurement system;
a memory that stores computer-executable instructions; and
a processor that executes the computer-executable instructions and causes the processor to:
measure the cable diameter with respect to upper limits of the cable diameter;
determine that the cable diameter is outside of the upper limits using the cable diameter measurements and cable parameter tolerances; and
initiate a signal to commence a remedial action, in response to determining that the cable diameter is outside of the upper limits.
